(19) United States
(12) Patent Application Publication
(10) Pub. No.: US 2021/0171786 A1
(43) Pub. Date: Jun. 10, 2021

(54) PROCESS FOR THE PREPARATION OF METALLIC NANO-PARTICLE LAYERS AND THEIR USE FOR DECORATIVE OR SECURITY ELEMENTS

(71) Applicant: BASF SE, Ludwigshafen am Rhein (DE)

(72) Inventors: Nikolay A GRIGORENKO, Basel (CH); Michelle RICHERT, Basel (CH)

(73) Assignee: BASF SE, Ludwigshafen am Rhein (DE)

(21) Appl. No.: 16/613,714

(22) PCT Filed: May 7, 2018
(86) PCT No.: PCT/EP2018/061665

§ 371 Date: Nov. 14, 2019

(30) Foreign Application Priority Data
May 15, 2017 (EP) 17170968.6

(51) Int. Cl. C09D 5/36; C09D 7/40; C09D 7/61; C09D 161/12; C09D 7/20; C09D 11/50; C09D 11/037; C09D 11/103; C09D 11/101; C09D 11/033; B42D 25/373; B42D 25/378; B44F 1/08; B22F 1/00; B22F 9/24; B41M 3/14; B41M 7/00

(52) U.S. Cl. CPC C09D 5/36; B42D 25/328; C09D 7/61; C09D 161/12; C09D 7/20; C09D 11/50; C09D 11/037; C09D 11/103; C09D 11/101; C09D 11/033; B42D 25/373; B42D 25/378; B44F 1/08; B22F 1/0018; B22F 9/24; B41M 3/14; B41M 7/0081; B41M 7/009; C09D 7/67

(57) ABSTRACT

The present invention relates to a process for the preparation of thin silver nanoparticle layers, which are produced directly on a substrate as part of a coating or printing process. The layers show different colours in transmittance and reflectance. The layers do not show the typical conductivity of metallic layers, since the particles are essentially discrete particles which are not sintered. The invention further relates to decorative and security elements. When the layers are applied over a security element, such as a hologram, the obtained products show also different colours in reflection and transmission, an extremely bright optically variable image (OVD image) and high purity and contrast. Depending on the thickness of the layer a more or less intensive metallic aspect appears.

The present invention relates to a process for the preparation of thin silver nanoparticles containing layers, which are produced directly on a substrate as part of a coating or printing process. The layers show different colours in transmittance and reflectance. The layers do not show the typical conductivity of metallic layers, since the particles are essentially discrete particles which are not sintered. The invention further relates to decorative and security elements. When the layers are applied over a security element, such as a hologram, the obtained products show also different colours in reflection and transmission, an extremely bright optically variable image (OVD image) and high purity and contrast. Depending on the thickness of the layer a more or less intensive metallic aspect appears.

DE102010004181 describes the preparation of silver or gold carboxylate complexes with an alkin ligand. These complexes serve as metal precursors in chemical vapour deposition processes (CVD).

WO2011/126706 discloses conductive films prepared from a silver complex formed by reaction of silver formiate or oxalate with an amine. These complexes may be part of a conductive ink which can be used in a printing process. The printed film is sintered and the layer exhibits a typical metallic conductivity.

US2006/0130700 describes a first ink jet ink containing a silver salt and an amine and a second ink jet ink containing a reducing agent. Both ink jet inks, when applied to a substrate subsequently or concurrently lead to a metallic pattern on the substrate.

WO2013/096664 discloses an ink composition and a method of making a conductive silver structure. The ink composition comprises a silver salt and a complex of a complexing agent and a salt of a short chain carboxylic acid. The complexing agent is, for example an alkyl amine or ammonia.

JP3-258589A relates to a method for producing an optical recording material, in which a reflective recording layer obtained by dispersing metal silver particles in a hydrophobic binder is laminated with a transparent substrate, and recording/reproduction is optically performed by way of the transparent substrate, wherein a silver catalyst nucleus or a catalyst nucleus comprising a metal nobler than silver is formed on a transparent substrate having transmittance of recording/reproduction light of 85% or greater and birefringence of 100 nm or less with a double pass, with substantially no change in reflectance, then a silver salt composition comprising an organic silver salt oxidant, a reducing agent and a hydrophobic binder is formed, and heating is then carried out at 100-200° C., whereby a metal silver particle-dispersed layer is densely formed on the substrate surface side of the silver salt composition and the reflectance through the transparent substrate is 10-90%.

JP4-40448A describes an optical recording material obtained by dispersing, in a hydrophobic binder, reflective metal microparticles obtained by reducing an organic silver salt compound and a compound of a metal other than silver.

US20030124259A1 (U.S. Pat. No. 7,629,017) relates to a metal precursor composition having a viscosity of at least about 1000 centipoise, comprising: (a) a metal precursor compound; and (b) a conversion reaction inducing agent in an amount sufficient to reduce the conversion temperature of said metal precursor composition by at least about 25° C. as compared to the dry metal precursor compound, wherein said conversion temperature is not greater than about 200° C.; and to a method for the fabrication of a conductive feature on a substrate, comprising the steps of: (a) providing a precursor composition comprising a metal precursor compound, wherein said precursor composition has a viscosity of at least about 1000 centipoise; (b) depositing said precursor composition on a substrate; and (c) heating said precursor composition to a conversion temperature of not greater than about 200° C. to form a conductive feature, wherein said conductive feature has a resistivity of not greater than about 10 times the resistivity of the pure bulk metal.

WO2003032084A2 relates to a metal precursor composition having a viscosity of not greater than 1000 centipoise, comprising: (a) a metal precursor compound; and (b) a conversion reaction inducing agent in an amount sufficient to reduce the conversion temperature of said metal precursor composition by at least about 25° C. compared to the dry metal precursor compound, wherein the conversion temperature of said metal precursor composition is not greater than about 200° C.; and a method for the fabrication of a conductive feature on a substrate, comprising the steps of: (a) providing a precursor composition comprising a silver metal precursor compound, wherein said precursor composition has a viscosity of not greater than about 50 centipoise and a surface tension of from about 20 to 50 dynes/cm; (b) depositing said precursor composition on a substrate; and (c) converting said precursor composition to a conductive feature by heating said precursor composition to a conversion temperature of not greater than about 250° C., wherein said conductive feature has a resistivity of not greater than about 10 times the resistivity of the pure bulk silver.

WO2016/170160 describes a method for forming an electrically non-conductive silver nanoparticles-containing layer on a substrate in a coating or printing process comprising the steps

A) coating or printing an ink composition on a substrate comprising

a) a silver compound or a mixture of silver compounds,

b) an alkine compound of formula (I), (II), (IIa), (III) or (IV),

c) optionally a solvent and/or an organic binder and/or reducing agent and/or formulation stabilizer and

B) heating the coated or printed substrate to a temperature of from 30° C. to 200° C. or applying electromagnetic radiation, preferably ultraviolet (UV) light or an electron beam.

It was the object of the present invention to provide a process for the preparation of highly reflective thin silver nano-particle layers, which are produced directly on a substrate as part of a coating or printing process. Advantageously, the curing temperature shall be low, i.e. below 140° C., which allows printing or coating process to be carried out at relatively high speed on temperature-sensitive substrates. At the same time, the ink formulation shall be stable for several hours at room temperature.

The present invention is directed to a method for forming silver nanoparticles-containing layer, especially an electrically non-conductive silver nanoparticles-containing layer, on a substrate comprising the steps

A) optionally forming an optically variable device (OVD) on a discrete portion of the substrate;

B) applying a composition on at least part of the substrate, and/or optionally at least part of the OVD obtained in step A), wherein the composition comprises

b1) a silver metal precursor,

b2) an acid,

b3) optionally a solvent,

b4) an optionally substituted polyhydric phenol (i.e. a polyhydric phenol which is optionally substituted), and

b5) optionally a polymeric binder,

C) exposing the coating obtained in step B) to heat and/or irradiating the coating with electromagnetic radiation, especially UV light, to form a highly reflective layer, especially an electrically non-conductive highly reflective layer, containing silver nanoparticles.

The silver nanoparticles containing layers show high gloss and different colours in transmittance and reflectance. The silver nanoparticles containing layers do not show the typical conductivity of metallic layers, since the particles are essentially discrete particles which are not sintered.

The invention further relates to decorative and security elements. When the silver nanoparticles containing layers are applied over a security element, such as a hologram, the obtained products show also different colours in reflection and transmission, an extremely bright optically variable image (OVD image) and high purity and contrast. Depending on the thickness of the layer a more or less intensive metallic appearance can be obtained.

In the context of the present invention the term “(electrically) non-conductive” means a resistance which is substantially higher than that of a metallic layer.

Typically the resistance of the layer after heating (the layer obtained in step C) is higher than 1*10³ Ω/sq, as measured by the four-point probe method. The four-point probe method is widely known and for example described in more detail in Smits, F. M., “Measurements of Sheet Resistivity with the Four-Point Probe”, BSTJ, 37, p. 371 (1958).

Preferably the sheet resistance of the layer after step C) is higher than 1*10⁴ Ω/sq as measured by four-point probe method.

The silver layer obtained by the above process is not a continuous metallic silver layer, but comprises preferably discrete separated nano-particles. Typically the longest dimension of particles is from 0.5 nm to 500 nm, preferably from 0.5 nm to 300 nm, in particular from 1 to 100 nm. Due to the separation of the particles the resulting layer or coating shows a certain color in transmission and a different colour in reflection. The composition of the present invention can be applied via a coating process or a printing process.

In general printing processes are preferred. Typical printing processes, which can be applied, are described below.

The highly reflective layer, containing silver nanoparticles, can be formed and/or the coating can be cured by heating the coated or printed substrate to a temperature of from 30 to 200° C., especially 30 to 140° C., and/or by applying electromagnetic radiation, preferably ultraviolet (UV) light, or an electron beam.

Preferably the electromagnetic radiation is ultraviolet (UV) light or an electron beam.

In case of irradiation with UV light, the usual UV light sources known in the art can be applied such as e.g. mercury lamps (optionally doped; exhibiting an intensity in the range of e.g. 100 to 400 W/cm², preferred 150 to 250 W/cm²), UV LEDs, lasers, high-intensity lamps (e.g. PulseForge® tool from Novacentrix). Preferably, the wavelength of the UV light sources is chosen in the range of from 200 to 400 nm.

The chosen exposure time depends on the used intensity, light source, layer thickness and curable composition, but usually is within the range of from 1 microsecond to 60 seconds, preferably from 10 microseconds to 20 seconds.

The highly reflective layer, containing silver nanoparticles, is preferably formed and/or the coating is preferably cured by heating the coated or printed substrate to a temperature of from 30 to 200° C., especially 30 to 140° C., most preferably from 0.5 seconds to 60 seconds.

As a rule, the heating step is carried out under atmospheric conditions and under normal pressure, for 0.1 seconds to 1000 seconds, preferably from 0.1 seconds to 500 seconds.

Prior to step C) a solvent evaporation step may be integrated, succeeding, for example, through thermal drying at a temperature in the range of from 20° C. to 120° C.

The final silver containing layer formed after step C) exhibits typically a thickness from 1 nm to 1000 nm, preferably from 5 nm to 500 nm, most preferably from 5 to 200 nm.

The composition normally comprises:

a total content of silver metal precursor(s) of from 0.1 to 40% by weight, preferably 0.1 to 20% by weight based on the total weight of the composition.

a total content of an acid of from 0.01 to 50% by weight, preferably 0.1 to 30% by weight based on the total weight of the composition.

a total content of solvent of from 10 to 99.5% by weight, preferably 30 to 98% by weight based on the total weight of the composition.

a total content of an optionally substituted polyhydric phenol of from 0.1 to 50% by weight, preferably 0.1 to 30% by weight based on the total weight of the composition.

a total content of a polymeric binder of from 0 to 30% by weight, preferably 0 to 10% by weight based on the total weight of the composition.

Generally, final composition should be in form of a solution in order to obtain a highly reflective silver nanoparticles containing layer.

Examples of silver metal precursors that can be used in the method of the present invention are silver carboxylates, silver halogencarboxylates, silver β-diketonates, silver complexes with β-ketoesters and mixtures thereof.

The silver metal precursors may be generated in situ. For example, silver oxide, silver carbonate, or silver acetate, may be reacted with trifluoroacetic acid to obtain silver trifluoroacetate.

The silver metal precursor is preferably selected from a compound of formula R¹¹C(═O)OAg (R¹¹ is a C₁-C₈alkyl group, wherein part of the hydrogen atoms may be replaced by F and/or Cl), such as, for example, silver trifluoroacetate, silver difluoroacetate, silver chlorodifluoroacetate, silver 3,3,3-trifluoropropionate, silver pentafluoropropionate, silver heptafluorobutyrate, silver heptafluoro isobutyrate, silver perfluoropentanoate, silver perfluorohexanoate, silver perfluoroheptanoate, silver perfluorooctanoate, silver acetate, silver propionate, silver butanoate, silver isobutanoate, silver pentanoate, silver hexanoate, silver ethylbutyrate, silver monochloroacetate, silver dichloroacetate, silver trichloroacetate, silver pivalate; a compound of formula R¹²C(═O)CH═C(—OAg)—R¹³ (R¹² and R¹³ are independently of each other a C₁-C₈alkyl group, wherein part of the hydrogen atoms may be replaced by F; or an optionally substituted phenyl group), such as, for example, silver acetylacetonate, silver 1,1,1-trifluoroacetylacetonate, silver 1,1,1,5,5,5-hexafluoroacetylacetonate, silver 1-phenyl-4,4,4-trifluorobutanedionate, silver 1-(4-methoxyphenyl)-4,4,4-trifluorobutanedionate; a compound of formula R¹⁴OC(═O)CH═C(—O)—R¹⁵Ag (R¹⁴ is a C₁-C₈alkyl group and R¹⁵ is a C₁-C₈alkyl group, wherein part of the hydrogen atoms may be replaced by F), such as, for example, a silver complex with ethyl acetoacetate, a silver complex with ethyl 3-oxo-4,4,4-trifluorobutanoate and mixtures thereof.

Among the above-mentioned silver metal precursors silver trifluoroacetate, silver difluoroacetate, silver pentafluoropropionate, silver heptafluorobutyrate, silver heptafluoro isobutyrate and silver hexafluoroacetylacetonate, silver acetate, silver propionate, silver butanoate, silver pentanoate, silver hexanoate or mixtures thereof are most preferred.

In one embodiment of the present invention the silver metal precursors are silver salts of those acids, which have a boiling or decomposition temperature of below 220° C. at atmospheric pressure.

In the context of the present invention an acid is an (organic) molecule capable of donating a proton (proton donor). Acids are preferred, which have a boiling or decomposition temperature of below 220° C. at atmospheric pressure and are stronger than acetic acid (pKₐ<4.76 measured in water). The acid is preferably selected from monochloroacetic acid, dichloroacetic acid, trichloroacetic acid, difluoroacetic acid, trifluoroacetic acid, pentafluoropropionic acid, heptafluorobutyric acid, perfluoropentanoic acid, perfluorohexanoic acid, perfluoroheptanoic acid, perfluorooctanoic acid and 1,1,1,5,5,5-hexafluoroacetylacetone or mixtures thereof.

The most preferred acids are trifluoroacetic acid, difluoroacetic acid, pentafluoropropionic acid, heptafluorobutyric acid and 1,1,1,5,5,5-hexafluoroacetylacetone and mixtures thereof.

The solvent is preferably selected from water, alcohols (such as methanol, ethanol, 1-propanol, 2-propanol, 1-butanol, 2-butanol, isobutanol, tert-butanol, tert-pentanol), cyclic or acyclic ethers (such as diethyl ether, tetrahydrofuran and 2-methyltetrahydrofurane), ketones (such as acetone, 2-butanone, 3-pentanone), ether-alcohols (such as 2-methoxyethanol, 1-methoxy-2-propanol, ethylene glycol monobutyl ether, diethylene glycol monoethyl ether, diethylene glycol monopropyl ether, and diethylene glycol monobutyl ether), polar aprotic solvents (such as acetonitrile, dimethyl formamide, and dimethyl sulfoxide), and mixtures thereof.

The solvent may be present in the (coating or printing ink) composition in an amount of from 10 to 99.5% by weight of the (coating or printing ink) composition, preferably 30 to 98% by weight.

A “polyhydric phenol” is a compound, containing an optionally substituted benzene ring and at least 2 hydroxy groups attached to it. The term “polyhydric phenol” comprises polyphenols, such as, for example, tannic acid and polycyclic aromatic hydrocarbons which consist of fused benzene rings, wherein at least one benzene ring has at least 2 hydroxy groups attached to it, such as, for example, 1,2-dihydroxynaphthalene. The “polyhydric phenol” may be substituted. Suitable substituents are described below.

The polyhydric phenol is preferably a compound of formula

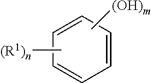

(I), wherein

R¹ can be the same, or different in each occurrence and is a hydrogen atom, a halogen atom, a C₁-C₁₈alkyl group, a C₁-C₁₈alkoxy group, or a group —C(═O)—R³,

R³ is a hydrogen atom, a C₁-C₁₈alkyl group, unsubstituted or substituted amino-group, or a C₁-C₁₈alkoxy group, and

n is a number of 1 to 4,

m is a number of 2 to 4, and

the sum of m and n is 6.

The polyhydric phenol is more preferably a compound of formula

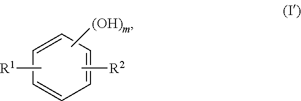

wherein

R¹ and R² are independently of each other a hydrogen atom, a C₁-C₁₈alkyl group, a C₁-C₁₈alkoxy group, or a group of formula —C(═O)—R³,

R³ is a hydrogen atom, a C₁-C₁₈alkyl group, an unsubstituted or substituted aminogroup, or a C₁-C₁₈alkoxy group, and

m is a number of 2 to 4, especially 2 to 3. Polyhydric phenols are preferred, which have two hydroxy groups in ortho- or para-position.

Even more preferably, the polyhydric phenol is a compound of formula

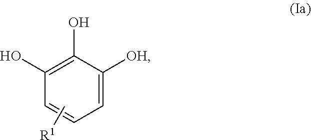

wherein R¹ is a hydrogen atom, or a group of formula —C(═O)—R³, wherein R³ is a hydrogen atom, a C₁-C₁₈alkyl group, or a C₁-C₁₈alkoxy group, an unsubstituted or substituted aminogroup, especially a C₁-C₁₈alkyl group or C₁-C₈alkoxy group.

Most preferably, the polyhydric phenol is a compound of formula

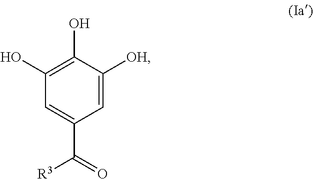

wherein R³ is a hydrogen atom, a C₁-C₁₈alkyl group, or a C₁-C₁₈alkoxy group, especially a C₁-C₈alkoxy group, such as, for example,

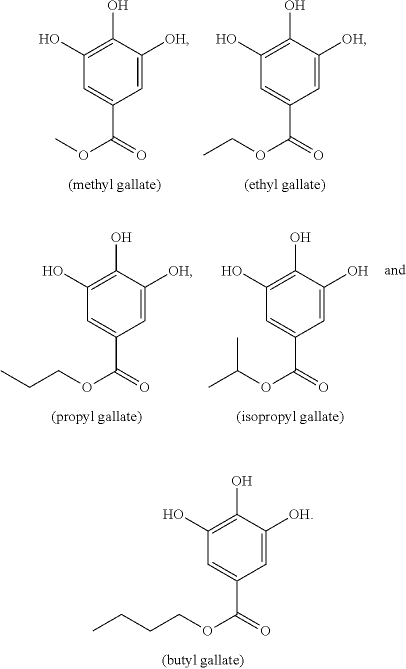 [SMILES: COC(=O)c1cc(O)c(O)c(O)c1 ; CCOC(=O)c1cc(O)c(O)c(O)c1 ; CCCOC(=O)c1cc(O)c(O)c(O)c1 ; CC(C)OC(=O)c1cc(O)c(O)c(O)c1 ; CCCCOC(=O)c1cc(O)c(O)c(O)c1]

In another preferred embodiment of the present invention the polyhydric phenols are compounds of formula

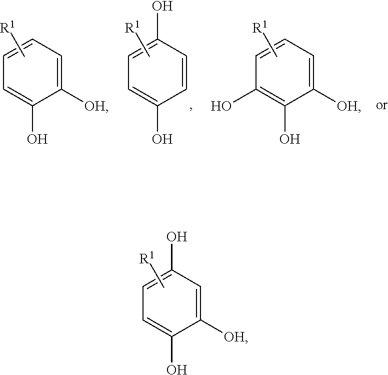

wherein R¹ is a hydrogen atom, or a group of formula —C(═O)—R³, wherein R³ is a hydrogen atom, a C₁-C₁₈alkyl group, or a C₁-C₁₈alkoxy group, an unsubstituted or substituted aminogroup, especially a C₁-C₁₈alkyl group or C₁-C₈alkoxy group.

An unsubstituted or substituted aminogroup is, for example, a group of formula —NR⁴R⁵, wherein R⁴ and R⁵ are independently of each other a hydrogen atom, a C₁-C₁₈alkyl group, a phenyl group, preferably a hydrogen atom, a C₁-C₁₈alkyl group.

Preferably the polyhydric phenols are used in a weight ratio to total silver content in the (coating or printing ink) composition from 0.1 to 10 by weight, more preferably from 0.2 to 3 by weight.

Halogen is fluorine, chlorine, bromine and iodine.

C₁-C₁₈alkyl means methyl, ethyl, n-, i-propyl, n-butyl, i-butyl, sec.-butyl, tert.-butyl, n-pentyl, neopentyl, n-hexyl, n-heptyl, n-octyl, 2-ethyl-hexyl, i-octyl, n-nonyl, n-decyl, i-decyl, n-undecyl, n-dodecyl, n-tridecyl, n-tetradecyl, n-pentydecyl, n-hexadecyl, n-heptadecyl, n-, i-octadecyl, preferably C₁-C₁₂alkyl such as methyl, ethyl, n-, i-propyl, n-butyl, i-butyl, sec.-butyl, tert.-butyl, n-pentyl, neopentyl, n-hexyl, n-heptyl, n-octyl, 2-ethyl-hexyl, i-octyl, n-nonyl, n-decyl, i-decyl, n-undecyl, n-dodecyl, i-dodecyl, more preferably C₁-C₈alkyl such as methyl, ethyl, n-, i-propyl, n-butyl, i-butyl, sec.-butyl, tert.-butyl, n-pentyl, neopentyl, n-hexyl.

C₁-C₁₈alkoxy groups are straight-chain or branched alkoxy groups, e.g. methoxy, ethoxy, n-propoxy, isopropoxy, n-butoxy, sec-butoxy, iso-butoxy, tert-butoxy, amyloxy, isoamyloxy or tert-amyloxy, heptyloxy, octyloxy, isooctyloxy, nonyloxy, decyloxy, undecyloxy, dodecyloxy, tetradecyloxy, pentadecyloxy, hexadecyloxy, heptadecyloxy and octadecyloxy. Examples of C₁-C₈alkoxy are methoxy, ethoxy, n-propoxy, isopropoxy, n-butoxy, sec.-butoxy, isobutoxy, tert.-butoxy, n-pentyloxy, 2-pentyloxy, 3-pentyloxy, 2,2-dimethylpropoxy, n-hexyloxy, n-heptyloxy, n-octyloxy, 1,1,3,3-tetramethylbutoxy and 2-ethylhexyloxy.

As substrate the usual substrates can be used. The substrates can be plain such as in metallic (e.g. Al foil) or plastic foils (e.g. PET foil), but paper is regarded also as a plain substrate in this sense.

Non-plain substrates or structured substrates comprise a structure, which was intentionally created, such as a hologram, or any other structure, created, for example, by embossing.

It is widely known to use in banknotes security elements in the form of strips or threads.

The method of the instant invention could replace the security elements in the form of strips or threads used in banknotes, which are made from a transparent film provided with a continuous reflective metal layer, vacuum deposited aluminium on polyester film being the commonest example.

The colours in transmission and reflection are dependent on the light-absorption spectrum of the coating and the colour in reflection may be complementary to the colour in transmission in the physical sense.

The compositions, preferably printing ink compositions may comprise a binder. Generally, the binder is a high-molecular-weight organic compound conventionally used in coating compositions. High molecular weight organic materials usually have molecular weights of about from 10³ to 10⁸ g/mol or even more. They may be, for example, natural resins, drying oils, rubber or casein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerisation, polycondensation or polyaddition. From the class of the polymerisation resins there may be mentioned, especially, polyolefins, such as polyethylene, polypropylene or polyisobutylene, and also substituted polyolefins, such as polymerisation products of vinyl chloride, vinyl acetate, styrene, acrylonitrile, acrylic acid esters, methacrylic acid esters or butadiene, and also copolymerisation products of the said monomers, such as especially ABS or EVA.

With respect to the binder resin, a thermoplastic resin may be used, examples of which include, polyethylene based polymers [polyethylene (PE), ethylene-vinyl acetate copolymer (EVA), vinyl chloride-vinyl acetate copolymer, vinyl alcohol-vinyl acetate copolymer, polypropylene (PP), vinyl based polymers [poly(vinyl chloride) (PVC), poly(vinyl butyral) (PVB), poly(vinyl alcohol) (PVA), poly(vinylidene chloride) (PVdC), poly(vinyl acetate) (PVAc), poly(vinyl formal) (PVF)], polystyrene based polymers [polystyrene (PS), styrene-acrylonitrile copolymer (AS), acrylonitrile-butadiene-styrene copolymer (ABS)], acrylic based polymers [poly(methyl methacrylate) (PMMA), MMA-styrene copolymer], polycarbonate (PC), celluloses [ethyl cellulose (EC), cellulose acetate (CA), propyl cellulose (CP), cellulose acetate butyrate (CAB), cellulose nitrate (CN), also known as nitrocellulose], fluorin based polymers [polychlorofluoroethylene (PCTFE), polytetrafluoroethylene (PTFE), tetrafluoroethylene-hexafluoroethylene copolymer (FEP), poly(vinylidene fluoride) (PVdF)], urethane based polymers (PU), nylons [type 6, type 66, type 610, type 11], polyesters (alkyl) [polyethylene terephthalate (PET), polybutylene terephthalate (PBT), polycyclohexane terephthalate (PCT)], novolac type phenolic resins, or the like. In addition, thermosetting resins such as resol type phenolic resin, a urea resin, a melamine resin, a polyurethane resin, an epoxy resin, an unsaturated polyester and the like, and natural resins such as protein, gum, shellac, copal, starch and rosin may also be used.

The binder preferably comprises nitrocellulose, ethyl cellulose, cellulose acetate, cellulose acetate propionate (CAP), cellulose acetate butyrate (CAB), hydroxyethyl cellulose (HEC), hydroxypropyl cellulose (HPC), alcohol soluble propionate (ASP), vinyl chloride, vinyl acetate copolymers, vinyl acetate, vinyl, acrylic, polyurethane, polyamide, rosin ester, hydrocarbon, aldehyde, ketone, urethane, polythyleneterephthalate, terpene phenol, polyolefin, silicone, cellulose, polyamide, polyester, rosin ester resins, shellac and mixtures thereof, most preferred are soluble cellulose derivatives such as hydroxylethyl cellulose, hydroxypropyl cellulose, nitrocellulose, carboxymethylcellulose as well as chitosan and agarose, in particular hydroxyethyl cellulose and hydroxypropyl cellulose.

Usually, the weight-ratio of binder to the total silver content (i.e. amount of silver equivalent to elementary silver) in the coating, or printing ink composition is chosen in the range of from 0.001 to 100, preferably from 0.001 to 10, most preferably 0.001 to 1.

The (coating or printing ink) compositions may also comprise an additional colorant. Examples for suitable dyes and pigments are given subsequently.

The (printing ink or coating) composition may also contain a surfactant. In general surfactants change the surface tension of the composition. Typical surfactants are known to the skilled person, they are for example, anionic or non-ionic surfactants. Examples of anionic surfactants can be, for example, a sulfate, sulfonate or carboxylate surfactant or a mixture thereof. Preference is given to alkylbenzenesulfonates, alkyl sulfates, alkyl ether sulfates, olefin sulfonates, fatty acid salts, alkyl and alkenyl ether carboxylates or to an a-sulfonic fatty acid salt or an ester thereof.

Preferred sulfonates are, for example, alkylbenzenesulfonates having from 10 to 20 carbon atoms in the alkyl radical, alkyl sulfates having from 8 to 18 carbon atoms in the alkyl radical, alkyl ether sulfates having from 8 to 18 carbon atoms in the alkyl radical, and fatty acid salts derived from palm oil or tallow and having from 8 to 18 carbon atoms in the alkyl moiety. The average molar number of ethylene oxide units added to the alkyl ether sulfates is from 1 to 20, preferably from 1 to 10. The cation in the anionic surfactants is preferably an alkaline metal cation, especially sodium or potassium, more especially sodium. Preferred carboxylates are alkali metal sarcosinates of formula R₉—CON(R₁₀)CH₂COOM₁ wherein R₉ is C₉-C₁₇alkyl or C₉-C₁₇alkenyl, R₁₀ is C₁-C₄alkyl and M₁ is an alkali metal such as lithium, sodium, potassium, especially sodium.

C₉-C₁₇alkyl means n-, i-nonyl, n-, i-decyl, n-, i-undecyl, n-, i-dodecyl, n-, i-tridecyl, n-, i-tetradecyl, n-, i-pentadecyl, n-, i-hexadecyl, n-, i-heptadecyl.

C₉-C₁₇alkenyl means n-, i-nonenyl, n-, i-decenyl, n-, i-undecenyl, n-, i-dodecenyl, n-, i-tridecenyl, n-, i-tetradecenyl, n-, i-pentadecenyl, n-, i-hexadecenyl, n-, i-heptadecenyl.

The non-ionic surfactants may be, for example, a primary or secondary alcohol ethoxylate, especially a C₈-C₂₀aliphatic alcohol ethoxylated with an average of from 1 to 20 mol of ethylene oxide per alcohol group. Preference is given to primary and secondary C₁₀-C₁₅ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

Further in addition, an auxiliary agent including a variety of reactive agents for improving drying property, viscosity, and dispersibility, may suitably be added. The auxiliary agents are to adjust the performance of the ink, and for example, a compound that improves the abrasion resistance of the ink surface and a drying agent that accelerates the drying of the ink and the like may be employed.

Furthermore, a plasticizer for stabilizing the flexibility and strength of the print film may be added according to the needs therefor.

The (coating or printing ink) composition may further contain a dispersant. The dispersant may be any polymer which prevents agglomeration or aggregation of the spherical and shaped particles formed after heating step C). The dispersant may be a non-ionic, anionic or cationic polymer having a weight average molecular weight of from 500 to 2,000,000 g/mol, preferably from 1,500,000 to 1,000,000 g/mol, which forms a solution or emulsion in the aqueous mixture. Typically, the polymers may contain polar groups. Suitable polymeric dispersants often possess a two-component structure comprising a polymeric chain and an anchoring group. The particular combination of these leads to their effectiveness.

Suitable commercially available polymeric dispersants are, for example, EFKA® 4046, 4047, 4060, 4300, 4330, 4580, 4585, 8512, Disperbyk® 161, 162, 163, 164, 165, 166, 168, 169, 170, 2000, 2001, 2050, 2090, 2091, 2095, 2096, 2105, 2150, Ajinomoto Fine Techno's PB® 711, 821, 822, 823, 824, 827, Lubrizol's Solsperse® 24000, 31845, 32500, 32550, 32600, 33500, 34750, 36000, 36600, 37500, 39000, 41090, 44000, 53095, ALBRITECT® CP30 (a copolymer of acrylic acid and acrylphosphonate) and combinations thereof.

Preference is given to polymers derived from hydroxyalkyl(meth)acrylates and/or polyglycol (meth)acrylates, such as hydroxyethyl and hydroxypropyl (meth)acrylate, polyethylene glycol (meth)acrylates, (meth)acrylates having amine functionality, for example, N-[3-(dimethylamino)propyl](meth)acrylamide or 2-(N,N-dimethylamino)ethyl(meth)acrylate.

In particular, non-ionic copolymer dispersants having amine functionality are preferred. Such dispersants are commercially available, for example as EFKA® 4300, EFKA® 4580 or EFKA 4585. The polymeric dispersants may be used alone or in admixture of two or more.

A photopolymerization-curable resin or an electron beam curable resin which is solvent-free may also be employed as a binder resin. The examples thereof include an acrylic resin, and specific examples of acrylic monomers commercially available are shown below.

A monofunctional acrylate monomer that may be used includes for example, 2-ethylhexyl acrylate, 2-ethylhexyl-E0 adduct acrylate, ethoxydiethylene glycol acrylate, 2-hydroxyethyl acrylate, 2-hydroxypropyl acrylate, 2-hydroxyethyl acrylate-caprolactone addduct, 2-phenoxyethyl acrylate, phenoxydiethylene glycol acrylate, nonyl phenol-EO adduct acrylate, (nonyl phenol-EO adduct)-caprolactone adduct acrylate, 2-hydroxy-3-phenoxypropyl acrylate, tetrahydrofurfuryl acrylate, furfuryl alcohol-caprolactone adduct acrylate, acryloyl morpholine, dicyclopentenyl acrylate, dicyclopentanyl acrylate, dicyclopentenyloxyethyl acrylate, isobornyl acrylate, (4,4-dimethyl-1,3-dioxane)-caprolactone adduct acrylate, (3-methyl-5,5-dimethyl-1,3-dioxane)-caprolactone adduct acrylate, and the like.

A polyfunctional acrylate monomer that may be used includes hexanediol diacrylate, neopentyl glycol diacrylate, polyethylene glycol diacrylate, tripropylene glycol diacrylate, neopentyl glycol hydroxypivalate diacrylate, (neopentyl glycol hydroxypivalate)-caprolactone adduct diacrylate, (1,6-hexanediol diglycidyl ether)-acrylic acid adduct, (hydroxypivalaldehyde-trimethylolpropane acetal) diacrylate, 2,2-bis[4-(acryloyloxydiethoxy)phenyl]propane, 2,2-bis[4-(acryloyloxydiethoxy)phenyl]methane, hydrogenated bisphenol A-ethylene oxide adduct diacrylate, tricyclodecanedimethanol diacrylate, trimethylolpropane triacrylate, pentaerithritol triacrylate, (trimethylolpropane-propylene oxide) adduct triacrylate, glycerine-propylene oxide adduct triacrylate, a mixture of dipentaerithritol hexaacrylate and pentaacrylate, esters of dipentaerithritol and lower fatty acid and acrylic acid, dipentaerithritol-caprolactone adduct acrylate, tris(acryloyloxyethyl) isocyanurate, 2-acryloyloxyethyl phosphate, and the like.

With respect to inks of ultraviolet-irradiation type curing among these inks, a photopolymerization initiator, and depending on the needs therefor, a sensitizing agent, and auxiliary agents such as a polymerization inhibitor and a chain transfer agent, and the like may be added thereto.

With respect to photo-polymerization initiators, there are, (1) an initiator of direct photolysis type including an arylalkyl ketone, an oxime ketone, an acylphosphine oxide, or the like, (2) an initiator of radical polymerization reaction type including a benzophenone derivative, a thioxanthone derivative, or the like, (3) an initiator of cationic polymerization reaction type including an aryl diazonium salt, an aryl iodinium salt, an aryl sulfonium salt, and an aryl acetophenone salt, or the like, and in addition, (4) an initiator of energy transfer type, (5) an initiator of photoredox type, (6) an initiator of electron transfer type, and the like. With respect to the inks of electron beam-curable type, a photopolymerization initiator is not necessary and a resin of the same type as in the case of the ultraviolet-irradiation type inks can be used, and various kinds of auxiliary agent may be added thereto according to the needs therefor.

The coating or printing ink composition of the present invention can be used in the manufacture of an optically variable image (OVD, which also includes optically variable devices, such as, for example, a hologram). Reference is made to WO2005/051675, WO2008/061930 and WO2012/176126.

A further specific embodiment of the invention concerns a preferred method for forming an optically variable device (OVD) on a substrate comprising the steps of:
A) forming an OVD on a discrete portion of the substrate;
   comprising
   a1) applying a curable composition to at least a portion of the substrate;
   a2) contacting at least a portion of the curable composition with OVD forming means; and
   a3) curing the curable composition treated in step a2),
B) applying a composition on at least part of the substrate, and/or optionally at least part of the OVD obtained in step a3), comprising
   b1) a silver metal precursor or a mixture of silver metal precursors,
   b2) an acid,
   b3) optionally a solvent,
   b4) an optionally substituted polyhydric phenol, and
   b5) optionally a polymeric binder,

C) exposing the coating obtained in step B) to heat and/or irradiating the coating with electromagnetic radiation, especially UV light, to form a highly reflective layer, especially an electrically non-conductive highly reflective layer, containing silver nanoparticles.

To accomplish the alignment of the silver particles formed to the contours of a diffraction grating the ink (coating composition) preferably has a very low binder and a low silver content.

Further details of such a method are described in FIG. 1 of WO08/061930, where certain substrates like paper, aluminium, or other opaque substrates (1) are printed with an UV curable lacquer (2) on its lower surface. An optically variable device, a lens or an engraved structure is cast (3) into the surface of the lacquer (2) with a clear shim (4) having the optically variable device or other lens or engraved structure thereon. The optically variable device, lens or engraved structure image is imparted into the lacquer and instantly cured (6) via an UV lamp disposed through the shim (4) at normal processing speeds through polarizing lens (8), quartz roller (6), and clear polycarbonate roller (5). The optically variable device, lens or engraved structure image is a facsimile of the image on the clear shim. Metallic ink (9) is printed (10) over the optically variable device or other lens or engraved structure and causes the optically variable device, lens or engraved structure to become light reflective. Further colours (11) can be subsequently conventionally printed in-line at normal printing process speeds. In an alternative embodiment, the paper, aluminium, and all manner of other opaque substrate (1) is replaced with a filmic substrate. Such material is substantially transparent and therefore the image is visible from both sides of the surface.

The coating, or printing ink composition of the present invention may be applied to the substrate by means of conventional printing press such as gravure, flexographic, lithographic, offset, letterpress intaglio and/or screen process, or other printing process.

Other digital printing processes are also possible, such as electrophotographic or ink jet processes.

In another embodiment, the composition may be applied by coating techniques, such as spraying, dipping, casting or spin-coating.

Preferably the printing process is carried out by flexographic, offset or by gravure printing.

The resulting products may be coated with a protective coating. The protective coating is preferably transparent or translucent. Examples for such coatings are known to the skilled person. For example, water borne coatings, UV-cured coatings or laminated coatings may be used. Suitable UV curable lacquers and coating methods are described, for example, WO2015/049262 and WO2016/156286.

In a specific embodiment in the method as described in claim 1, steps A) to C) are repeated 1 to 5 times resulting in a multilayer metallic structure.

In some cases, it might be suitable to apply a neutral or protective coating between the repeatedly applied metallic coatings, such as, for example, an UV curable lacquer. Suitable UV curable lacquers and coating methods are described, for example, WO2015/049262 and WO2016/156286.

The (security, or decorative) product obtainable by using the above method forms a further subject of the present invention.

Accordingly, the present invention is directed to a security, or decorative element, comprising a substrate, which may contain indicia or other visible features in or on its surface, and on at least part of the said substrate surface, a highly reflective layer, especially an electrically non-conductive highly reflective layer, containing silver nanoparticles, which is obtainable according to the method of the present invention.

Typically, the security product includes banknotes, credit cards, identification documents like passports, identification cards, driver licenses, or other verification documents, pharmaceutical apparel, software, compact discs, tobacco packaging and other products or packaging prone to counterfeiting or forgery.

The substrate may comprise any sheet material. The substrate may be opaque, substantially transparent or translucent, wherein the method described in WO08/061930 is especially suited for substrates, which are opaque to UV light (non-transparent). The substrate may comprise paper, leather, fabric such as silk, cotton, tyvac, filmic material or metal, such as aluminium. The substrate may be in the form of one or more sheets or a web.

The substrate may be mould made, woven, non-woven, cast, calendared, blown, extruded and/or biaxially extruded. The substrate may comprise paper, fabric, man made fibres and polymeric compounds. The substrate may comprise any one or more selected from the group comprising paper, papers made from wood pulp or cotton or synthetic wood free fibres and board. The paper/board may be coated, calendared or machine glazed; coated, uncoated, mould made with cotton or denim content, Tyvac, linen, cotton, silk, leather, polythyleneterephthalate, polypropylene propafilm, polyvinylchloride, rigid PVC, cellulose, tri-acetate, acetate polystyrene, polyethylene, nylon, acrylic and polytherimide board. The polythyleneterephthalate substrate may be Melinex type film orientated polypropylene (obtainable from DuPont Films Willimington Delaware product ID Melinex HS-2).

The substrates being transparent films or non transparent substrates like opaque plastic, paper including but not limited to banknote, voucher, passport, and any other security or fiduciary documents, self adhesive stamp and excise seals, card, tobacco, pharmaceutical, computer software packaging and certificates of authentication, aluminium, and the like.

In a preferred embodiment of the present invention the substrate is a non-transparent (opaque) sheet material, such as, for example, paper. Advantageously, the paper may be precoated. Generally, any coating or protective layer, which would be able to prevent penetration of the composition of the present invention into paper, is suitable, such as, for example, an UV curable lacquer. Suitable UV curable lacquers and coating methods are described, for example, WO2015/049262 and WO2016/156286.

In another preferred embodiment of the present invention the substrate is a transparent or translucent sheet material, such as, for example, polythyleneterephthalate (a biaxially oriented polyethylene terephthalate (BOPET) film, or a biaxially oriented polypropylene (BOPP) film).

The forming of an optically variable image on the substrate may comprise depositing a curable composition on at least a portion of the substrate, as described above. The curable composition, generally a coating or lacquer may be deposited by means of gravure, flexographic, ink jet and screen process printing. The curable lacquer may be cured by actinic radiations, preferably ultraviolet (UV) light or electron beam. Preferably, the curable lacquer is UV cured. UV curing lacquers are well known and can be obtained from e.g. BASF SE. The lacquers exposed to actinic radiations or electron beam used in the present invention are required to reach a solidified stage when they separate again from the imaging shim in order to keep the record in their upper layer of the sub-microscopic, holographic diffraction grating image or pattern (optically variable image, OVI). Particularly suitable for the lacquer compositions are mixtures of typical well-known components (such as photoinitiators, monomers, oligomers. levelling agents etc.) used in the radiation curable industrial coatings and graphic arts. Particularly suitable are compositions containing one or several photo-latent catalysts that will initiate polymerization of the exposed lacquer layer to actinic radiations. Particularly suitable for fast curing and conversion to a solid state are compositions comprising one or several monomers and oligomers sensitive to free-radical polymerization, such as acrylates, methacrylates or monomers or/and oligomers, containing at least one ethylenically unsaturated group, examples have already been given above. Further reference is made to pages 8 to 35 of WO2008/061930.

The UV lacquer may comprise an epoxy-acrylate from the CRAYNOR® Sartomer Europe range (10 to 60%) and one or several acrylates (monofunctional and multifunctional), monomers which are available from Sartomer Europe (20 to 90%) and one, or several photoinitiators (1 to 15%) such as Darocure® 1173 and a levelling agent such as BYK® 361 (0.01 to 1%) from BYK Chemie.

The curable composition is preferably deposited by means of gravure or flexographic printing.

The curable composition can be coloured.

A filmic substrate is printed conventionally with a number of coloured inks, using, for example, a Cerutti R950 printer (available from Cerrutti UK Long Hanborough Oxon.). The substrate is then printed with an ultra violet curable lacquer. An OVD is cast into the surface of the curable composition with a shim having the OVD thereon, the holographic image is imparted into the lacquer and instantly cured via a UV lamp, becoming a facsimile of the OVD disposed on the shim.

The diffraction grating may be formed using any methods known to the skilled man such as those described in U.S. Pat. Nos. 4,913,858, 5,164,227, WO2005/051675 and WO2008/061930.

The curable coating composition may be applied to the substrate by means of conventional printing press such as gravure, rotogravure, flexographic, lithographic, offset, letterpress intaglio and/or screen process, or other printing process.

Preferably, when the substrate carrying the enhanced diffractive image or pattern is subsequently over-laid onto printed pictures and/or text, or the substrate is preprinted with pictures and/or text and the enhanced diffractive image or pattern is deposited thereon, those printed features are visible through the substrate, provided that the substrate itself is at least opake, translucent or transparent. Preferably the silver layer which is printed over the OVD, for example the diffraction grating is also sufficiently thin as to allow viewing in transmission and reflectance. In other words the whole security element on the substrate allows a viewing in transmission and reflectance.

In another preferred embodiment the security element comprises a mutlilayer structure capable of interference, wherein the multilayer structure capable of interference has a reflection layer, a dielectric layer, and a partially transparent layer (EP1504923, WO01/03945, WO01/53113, WO05/38136, WO16173696), wherein the dielectric layer is arranged between the reflection layer and the partially transparent layer and the reflective layer is formed by the highly reflective layer, containing silver nanoparticles, which is obtainable according to the method of the present invention.

Suitable materials for the absorber layer include an Ni/Cr/Fe semi-transparent alloy, chromium, nickel, aluminum, silver, copper, palladium, platinum, titanium, vanadium, cobalt, iron, tin, tungsten, molybdenum, rhodium, niobium, carbon, graphite, silicon, germanium and compounds, mixtures or alloys thereof. Suitable materials for the dielectric layer include silicium dioxide, zinc sulfide, zinc oxide, zirconium oxide, zirconium dioxide, titanium dioxide, diamond-like carbon, indium oxide, indium-tin-oxide, tantalum pentoxide, cerium oxide, yttrium oxide, europium oxide, iron oxides, hafnium nitride, hafnium carbide, hafnium oxide, lanthanum oxide, magnesium oxide, magnesium fluoride, neodymium oxide, praseodymium oxide, samarium oxide, antimony trioxide, silicon monoxide, selenium trioxide, tin oxide, tungsten trioxide and combinations thereof as well as organic polymer acrylates.

The absorber layer is preferebaly an Ni/Cr/Fe semi-transparent alloy and the dielectric layer is preferably formed of SiO₂.

The curable composition may further comprise modifying additives, for example colorants and/or suitable solvent(s).

Preferably, the resin maintains adhesion of the composition to the surface of the diffraction grating.

Specific additives can be added to the composition to modify its chemical and/or physical properties. Polychromatic effects can be achieved by the introduction of (colored) inorganic and/or organic pigments and/or solvent soluble dyestuffs into the ink, to achieve a range of coloured shades. By addition of a dye the transmission colour can be influenced. By the addition of fluorescent or phosphorescent materials the transmission and/or the reflection colour can be influenced.

Suitable colored pigments especially include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, the 2,9-dichloro-quinacridone in platelet form described in WO08/055807, or a mixture or solid solution thereof.

Plateletlike organic pigments, such as plateletlike quinacridones, phthalocyanine, fluororubine, dioxazines, red perylenes or diketopyrrolopyrroles can advantageously be used.

Suitable colored pigments also include conventional inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate, Prussian blue, Fe₃O₄, carbon black and mixed metal oxides.

Examples of dyes, which can be used to color the curable composition, are selected from the group consisting of azo, azomethine, methine, anthraquinone, phthalocyanine, dioxazine, flavanthrone, indanthrone, anthrapyrimidine and metal complex dyes. Monoazo dyes, cobalt complex dyes, chrome complex dyes, anthraquinone dyes and copper phthalocyanine dyes are preferred.

The optically variable device (OVD) is, for example, a diffractive optical variable image (DOVI). The term “diffractive optical variable image” as used herein may refer to any type of holograms including, for example, but not limited to a multiple plane hologram (e.g., 2-dimensional hologram, 3-dimensional hologram, etc.), a stereogram, and a grating image (e.g., dot-matrix, pixelgram, exelgram, kinegram, etc.).

Examples of an optically variable device are holograms or diffraction gratings, moire grating, lenses etc (embossed layers with diffractive gratings and/or micromirrors and/or lenses). These optical microstructured devices (or images) are composed of a series of structured surfaces. These surfaces may have straight or curved profiles, with constant or random spacing, and may even vary from nanometers to millimetres in dimension. Patterns may be circular, linear, or have no uniform pattern. For example, a Fresnel lens has a microstructured surface on one side and a plane surface on the other. The microstructured surface consists of a series of grooves with changing slope angles as the distance from the optical axis increases. The draft facets located between the slope facets usually do not affect the optical performance of the Fresnel lens.

A further aspect of the present invention is the use of the element as described above for the prevention of counterfeit or reproduction, on a document of value, right, identity, a security label or a branded good.

Yet a further aspect of the invention is a (coating or printing ink) composition comprising

b1) a silver metal precursor,

b2) an acid,

b3) optionally a solvent,

b4) a polyhydric phenol, and

b5) optionally a polymeric binder.

The preferences for components b1) to b5) have already been described above.

Preferably, the (coating or printing ink) composition comprises

b1) the silver metal precursor is selected from from a compound of formula R¹¹C(═O)OAg, wherein R¹¹ is a C₁-C₈alkyl group, wherein part of the hydrogen atoms may be replaced by F and/or Cl, such as, for example, silver trifluoroacetate, silver difluoroacetate, silver chlorodifluoroacetate, silver 3,3,3-trifluoropropionate, silver pentafluoropropionate, silver heptafluorobutyrate, silver heptafluoro isobutyrate, silver perfluoropentanoate, silver perfluorohexanoate, silver perfluoroheptanoate, silver perfluorooctanoate, silver acetate, silver propionate, silver butanoate, silver isobutanoate, silver pentanoate, silver hexanoate, silver ethylbutyrate, silver monochloroacetate, silver dichloroacetate, silver trichloroacetate, silver pivalate; a compound of formula R¹²C(═O)CH═C(—OAg)—R¹³, wherein R¹² and R¹³ are independently of each other a C₁-C₈alkyl group, wherein part of the hydrogen atoms may be replaced by F; or an optionally substituted phenyl group, such as, for example, silver acetylacetonate, silver 1,1,1-trifluoroacetylacetonate, silver 1,1,1,5,5,5-hexafluoroacetylacetonate, silver 1-phenyl-4,4,4-trifluorobutanedionate, silver 1-(4-methoxyphenyl)-4,4,4-trifluorobutanedionate; a compound of formula R¹⁴OC(═O)CH═C(—O)—R¹⁵Ag, wherein R¹⁴ is a C₁-C₈alkyl group and R¹⁵ is a C₁-C₈alkyl group, wherein part of the hydrogen atoms may be replaced by F, such as, for example, a silver complex with ethyl acetoacetate, a silver complex with ethyl 3-oxo-4,4,4-trifluorobutanoate; and mixtures thereof,

b2) the acid is selected from monochloroacetic acid, dichloroacetic acid, trichloroacetic acid, difluoroacetic acid, trifluoroacetic acid, pentafluoropropionic acid, heptafluorobutyric acid, perfluoropentanoic acid, perfluorohexanoic acid, perfluoroheptanoic acid, perfluorooctanoic acid and 1,1,1,5,5,5-hexafluoroacetylacetone, and mixtures thereof,

b3) the solvent is selected from water, alcohols (such as methanol, ethanol, 1-propanol, 2-propanol, 1-butanol, 2-butanol, isobutanol, tert-butanol, tert-pentanol), cyclic or acyclic ethers (such as diethyl ether, tetrahydrofuran and 2-methyltetrahydrofurane), ketones (such as acetone, 2-butanone, 3-pentanone), ether-alcohols (such as 2-methoxyethanol, 1-methoxy-2-propanol, ethylene glycol monobutyl ether, diethylene glycol monoethyl ether, diethylene glycol monopropyl ether, and diethylene glycol monobutyl ether), polar aprotic solvents (such as acetonitrile, dimethyl formamide, and dimethyl sulfoxide), and mixtures thereof;

and/or

b4) the polyhydric phenol is a compound of formula

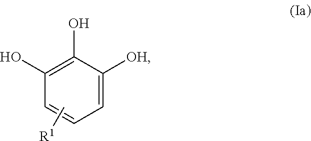

wherein R¹ is a hydrogen atom, or a group of formula —C(═O)—R³, wherein R³ is a hydrogen atom, a C₁-C₁₈alkyl group, or a C₁-C₁₈alkoxy group, an unsubstituted or substituted aminogroup, especially a C₁-C₁₈alkyl group or C₁-C₈alkoxy group.

Various aspects and features of the present invention will be further discussed in terms of the examples. The following examples are intended to illustrate various aspects and features of the present invention.

### EXAMPLES

### Example 1

General Procedure:

116 mg (0.5 mmol) of Ag₂O was added to 2.5 g of 1-methoxy-2-propanol, followed by 171 mg (1.5 mmol) of trifluoroacetic acid and the mixture was stirred for 15 min at 25° C. for dissolution of Ag₂O. After that, 0.5 mmol of compound X (see table 1, except for tannic acid, which was added in the amount of 85 mg (0.05 mmol)) was added with stirring, followed by addition of 1-methoxy-2-propanol such as to adjust the Ag concentration in the mixture to 3% w/w. The mixture was filtered through 0.45 μm PTFE syringe filter and coated onto flexible PET-foil substrate (Melinex 506) using a wire bar #1 (6 micrometers wet film). Coating was dried and cured in the oven at 95° C. for 30 sec. Gloss measurements were carried out using a glossmeter Zehntner 1110 (Table 1). Coloristic measurements were carried out using a spectrophotometer X-RITE SP68 at 10° observation angle over white background (Table 1).

TABLE 1
Coloristic and gloss properties for coatings, obtained in Example 1.

| | | Gloss | L* | C* | h |
|---|---|---|---|---|---|
| Sample | | (20° | (over | (over | (over |
| ID | Structure of compound X | angle | white) | white) | white) |
| 1.0 | Melinex 506 | 227 | — | — | — |
| | (blank PET substrate) | | | | |
| 1.1 | 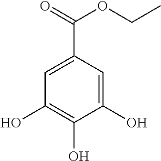 | 400 | 65 | 27.1 | 64 |
| 1.2 | 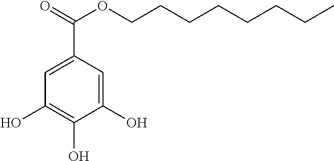 [SMILES: CCCCCCCCOC(=O)c1cc(O)c(O)c(O)c1] | 402 | 63.3 | 26.1 | 61.8 |
| 1.3 | 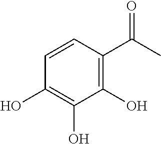 | 569 | 66.5 | 17.4 | 73.9 |
| 1.4 | 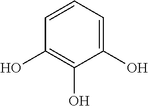 | 521 | 66.7 | 23 | 74.6 |
| 1.5 | 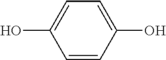 | 628 | 73.2 | 8.5 | 84.1 |
| 1.6 | 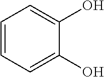 | 509 | 65.8 | 12.3 | 81.8 |
| 1.7 | Tannic acid | 335 | 69.9 | 34.2 | 63.9 |

As can be seen from the data in Table 1, higly reflective coatings can be obtained upon coating and curing the compositions of the present invention at a temperature as low as 95° C.

### Example 2

a) Two solutions were prepared:

Solution A: 11.5 g (50 mmol) Ag₂O was added to 200 g of 1-methoxy-2-propanol, followed by addition of 14.8 g (130 mmol) of trifluoroacetic acid. The mixture was stirred until dissolution of Ag₂O (approximately 10 min).

Solution B: 9.9 g (50 mmol) of ethyl gallate was dissolved in 200 g of 1-methoxy-2-propanol.

b) Solutions A and B from Example 2a) were mixed and the resulting mixture was printed onto PET foil (Melinex 506) by rotogravure using a 70 l/cm gravure cylinder at a speed of 10 m/min to 20 m/min and 120° C. drying temperature.

Gloss measurements were carried out using a glossmeter Zehntner 1110. Coloristic measurements were carried out using a spectrophotometer X-RITE SP68 at 10° observation angle over white background (Tables 2 and 3).

TABLE 2
Gloss properties of the coatings, obtained in Example 2

| | | | Melinex |
|---|---|---|---|
| Angle | 10 m/min | 20 m/min | 506 |
| 20° | 928 | 891 | 226 |
| 60° | 426 | 409 | 202 |
| 85° | 112 | 112 | 121 |

TABLE 3
Coloristic data of the coatings, obtained in Example 2

| | Speed | |
|---|---|---|
| | 10 m/min | 20 m/min |
| L* | 78.6 | 77.3 |
| C* | 17.7 | 18.3 |
| h | 71.6 | 70.2 |

As can be seen from the data in Tables 2 and 3, with a composition according to the present invention, a highly reflective (high gloss value at 20°) coating can be obtained with a printing speed of up to 20 m/min with a given drying chamber length. Increasing the drying chamber length to such as found in industrial printing mashines would allow for further increase of printing speed without losing the reflectivity.

1. A method for forming a silver nanoparticles-containing layer on a substrate, the method comprising:
A) optionally forming an optically variable device (OVD) on a discrete portion of the substrate;
B) applying a composition on at least part of the substrate, optionally on at least part of the OVD obtained in step A), or both, to obtain a coating; and
C) exposing the coating to heat, irradiating the coating with electromagnetic radiation, or both, to form a highly reflective layer comprising silver nanoparticles,
wherein the composition comprises:
b1) a silver metal precursor,
b2) an acid,
b3) optionally a solvent,
b4) an optionally substituted polyhydric phenol, and
b5) optionally a polymeric binder.

2. The method according to claim 1, wherein the silver metal precursor is selected from the group consisting of:
a compound of formula R¹¹C(═O)OAg, wherein R¹¹ is a C₁-C₈alkyl group, wherein part of the hydrogen atoms may be replaced by F and/or Cl,
a compound of formula R¹²C(═O)CH═C(—OAg)—R¹³, wherein R¹² and R¹³ are independently of each other a C₁-C₈alkyl group, wherein part of the hydrogen atoms may be replaced by F, or an optionally substituted phenyl group,
a compound of formula R¹⁴OC(═O)CH═C(—OAg)—R¹⁵, wherein R¹⁴ is a C₁-C₈alkyl group and R¹⁵ is a C₁-C₈alkyl group, wherein part of the hydrogen atoms may be replaced by F, and
mixtures thereof.

3. The method according to claim 1, wherein the acid is selected from the group consisting of monochloroacetic acid, dichloroacetic acid, trichloroacetic acid, difluoroacetic acid, trifluoroacetic acid, pentafluoropropionic acid, heptafluorobutyric acid, perfluoropentanoic acid, perfluorohexanoic acid, perfluoroheptanoic acid, perfluorooctanoic acid and 1,1,1,5,5,5-hexafluoroacetylacetone, and mixtures thereof.

4. The method according to claim 1, wherein the composition comprises a solvent selected from the group consisting of water, an alcohol, an ether, a ketone, an ether-alcohol, a polar aprotic solvent, and mixtures thereof.

5. The method according to claim 1, wherein the composition comprises a polyhydric phenol, which is tannic acid or a compound of formula (I): 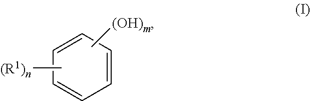
wherein:
R¹ can be the same, or different in each occurrence and is a hydrogen atom, a halogen atom, a C₁-C₁₈alkyl group, a C₁-C₁₈alkoxy group, or a group —C(═O)—R³,
R³ is a hydrogen atom, a C₁-C₁₈alkyl group, anunsubstituted or substituted aminogroup, or a C₁-C₁₈alkoxy group, and
n is a number of 1 to 4,
m is a number of 2 to 4, and
the sum of m and n is 6.

6. The method according to claim 5, wherein the polyhydric phenol is a compound of formula (Ia): 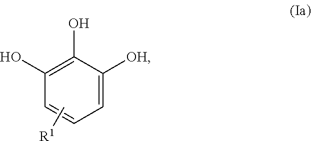
wherein:
R¹ is a hydrogen atom, or a group of formula —C(═O)—R³, and
R³ is a hydrogen atom, a C₁-C₁₈alkyl group, a C₁-C₁₈alkoxy group, or an unsubstituted or substituted aminogroup.

7. The method according to claim 1, wherein the composition comprising a polymeric binder selected from the group consisting of a nitrocellulose, an ethyl cellulose, a cellulose acetate, a cellulose acetate propionate (CAP), a cellulose acetate butyrate (CAB), a hydroxyethyl cellulose, a hydroxypropyl cellulose, an alcohol soluble propionate (ASP), a vinyl chloride, a vinyl acetate copolymer, a vinyl acetate, a vinyl, an acrylic, a polyurethane, a polyamide, a rosin ester, a hydrocarbon-containing binding, an aldehyde-containing binder, a ketone-containing binder, a urethane-containing binder, a polyethyleneterephthalate, a terpene phenol, a polyolefin, a shellac and mixtures thereof.

8. The method according to claim 1, comprising:
a1) applying a curable composition to at least a portion of the substrate;
a2) contacting at least a portion of the curable composition with OVD former; and
a3) curing the curable composition treated in step a2) by the OVD former.

9. A security or decorative element, comprising
a substrate, which may contain indicia or other visible features in or on its surface, and
on at least part of the substrate surface, a silver layer obtained by the method of claim 1.

10. The security or decorative element according to claim 9, wherein the silver layer is coated with a protective layer.

11. An article, comprising the security or decorative element of claim 9.

12. A coating or printing ink composition, comprising:
b1) a silver metal precursor,
b2) an acid,
b3) optionally a solvent,
b4) a polyhydric phenol, and
b5) optionally a polymeric binder.

13. The coating or printing ink composition according to claim 12, comprising:
the silver metal precursor b1) selected from the group consisting of
a compound of formula R¹¹C(═O)OAg, wherein R¹¹ is a C₁-C₈alkyl group, wherein part of the hydrogen atoms may be replaced by F and/or Cl,
a compound of formula R¹²C(═O)CH═C(—OAg)—R¹³, wherein R¹² and R¹³ are independently of each other a C₁-C₈alkyl group, wherein part of the hydrogen atoms may be replaced by F, or an optionally substituted phenyl group,
a compound of formula R¹⁴OC(═O)CH═C(—OAg)—R¹⁵, wherein R¹⁴is a C₁-C₈alkyl group and R¹⁵ is a C₁-C₈alkyl group, wherein part of the hydrogen atoms may be replaced by F, and
mixtures thereof;
an acid b2) selected from the group consisting of monochloroacetic acid, dichloroacetic acid, trichloroacetic acid, difluoroacetic acid, trifluoroacetic acid, pentafluoropropionic acid, heptafluorobutyric acid, perfluoropentanoic acid, perfluorohexanoic acid, perfluoroheptanoic acid, perfluorooctanoic acid and 1,1,1,5,5,5-hexafluoroacetylacetone, and mixtures thereof;
a solvent b3) selected from the group consisting of water, an alcohol, a cyclic or acyclic ether, a ketone, a polar aprotic solvent, and mixtures thereof; and
a polyhydric phenol of formula (Ia): 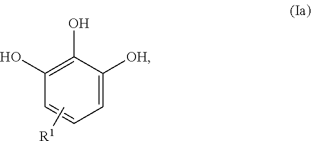
wherein:
R¹ is a hydrogen atom, or a group of formula —C(═O)—R³, and
R³ is a hydrogen atom, a C₁-C₁₈alkyl group, a C₁-C₁₈alkoxy group, or an unsubstituted or substituted aminogroup.

14. A reflective layer formed from the coating or printing ink composition claim 12.
